(19) United States
(12) Patent Application Publication
(10) Pub. No.: US 2017/0293972 A1
(43) Pub. Date: Oct. 12, 2017

(54) METHODS FOR PROVIDING OVERDRAFT LINES OF CREDIT TO NON-ACCOUNT HOLDERS AND DEVICES THEREOF

(71) Applicant: Michael van Bemmelen, Teaneck, NJ (US)

(72) Inventor: Michael van Bemmelen, Teaneck, NJ (US)

(21) Appl. No.: 15/485,014

(22) Filed: Apr. 11, 2017

Related U.S. Application Data
(60) Provisional application No. 62/321,515, filed on Apr. 12, 2016.

(51) Int. Cl. G06Q 40/02

(52) U.S. Cl. CPC G06Q 40/025

(57) ABSTRACT

A method for generating a third-party lender overdraft line of credit includes accessing, by an overdraft management computing device, real-time bank account information. An insufficient fund amount is identified based on the real-time bank account information. An overdraft score is generated based on the insufficient fund amount, the real-time bank account information, and a third-party lender rule set established by a third-party lender and stored on the overdraft management computing device. An overdraft approval is provided when the overdraft score is above a threshold provided by the third-party lender and stored on the overdraft management computing device. The overdraft approval is provided without sending confidential user information to the third-party lender and automatically generates the third-party lender overdraft line of credit for the user.

This application claims the benefit of U.S. Provisional Patent Application Ser. No. 62/321,515 filed Apr. 12, 2016, which is hereby incorporated by reference in its entirety.

### FIELD

This technology relates to a method, device, and non-transitory computer readable medium that provides security, both with regard to fraud protection and to privacy safeguards, for bank customers and prospective third-party lenders providing overdraft protection.

### BACKGROUND

Bank customers are captive to their account bank for obtaining overdraft protection. An overdraft occurs when all funds in the customer account have been spent, but the customer continues to make payments by check, account-linked debit card, or the account is automatically debited through ACH for recurring utility payments and similar.

Banks make extensive use of sophisticated algorithms to maximize their fee income from overdrafts, while banks' profit opportunities are largely unencumbered by regulation in this area. An overdraft is expensive for the consumer, on average $35 for any advance over $5, even if drawn for just one day. Recent regulations require banks to obtain customer “opt-in” for overdrafts, but not receiving an overdraft is even more expensive, since not-sufficient fees (“NSF”) assessed by the account bank on a bounced check are also typically $35. Additionally, the bank where the bounced check is presented imposes similar-sized fees. Moreover, there is a factor of embarrassment connected to a bounced check for a consumer, and additionally for a small business, potential loss of confidence with a supplier. For both categories of bank customers, the occurrence of NSF or incurring overdraft fees from the account bank carry negative consequences for credit ratings and, thus, may increase future costs of borrowing.

The short-term monopoly power of the account bank results in a high fee structure. Consumers would benefit from third-party lenders providing overdraft lines to replace or supplement account banks. However, the account bank has unique access to real-time account information. Lack of trust with confidential information, provided over the internet, and lack of verifiability, both on the side of the consumer with respect to the potential new lender, and vice versa, has preserved the overdraft monopoly.

It would be very profitable for a third-party financial institution to have the opportunity to compete for the overdraft business of account holders at other banks. Official Bank Call Reports for 2016 reveal that the three largest U.S. banks received a combined total of $5.4 billion in overdraft fees.

The third-party lender can provide the overdraft protection to a small business in the form of a purchase of receivables or credit card receipts, i.e., as an unregulated provider of factoring finance. To bank customers who are individuals, the third-party overdraft line would originate at a regulated lending institution, since bank regulators may view the service as a loan product.

Traditionally the providing of overdraft protection has been limited to the account bank for security reasons affecting both the potential provider as well as the account holder, including the following: (1) security and privacy concerns regarding transmission and storage of bank account transactional information to a third-party; (2) the proliferation of databases that house and transfer Account Credentials and transactions for millions of persons (such as Mint—these databases and transmissions have become prime targets for unstoppable hackers); (3) security concerns in providing account credentials to an outside party for repeated access of a customer bank account; and (4) security and credit risk concerns, as well as potential fraud and data breach concerns affecting prospective third-party lenders.

The present technology is directed to overcoming these and other deficiencies in the art.

### SUMMARY

A method for generating a third-party lender overdraft line of credit includes accessing, by an overdraft management computing device, real-time bank account information. An insufficient fund amount is identified based on the real-time bank account information. An overdraft score is generated based on the insufficient fund amount, the real-time bank account information, and a third-party lender rule set established by a third-party lender and stored on the overdraft management computing device. An overdraft approval is provided when the overdraft score is above a threshold provided by the third-party lender and stored on the overdraft management computing device. The overdraft approval is provided without sending confidential user information to the third-party lender. An approval code is sent to the third-party lender. The approval code automatically generates the third-party lender overdraft line of credit for the user.

An overdraft management computing device includes a processor and a memory coupled to the processor which is configured to execute one or more programmed instructions comprising and stored in the memory to access real-time bank account information. An insufficient fund amount is identified based on the real-time bank account information. An overdraft score is generated based on the insufficient fund amount, the real-time bank account information, and a third-party lender rule set established by a third-party lender and stored on the overdraft management computing device. An overdraft approval is provided when the overdraft score is above a threshold provided by the third-party lender and stored on the overdraft management computing device. The overdraft approval is provided without sending confidential user information to the third-party lender. An approval code is sent to the third-party lender. The approval code automatically generates the third-party lender overdraft line of credit for the user.

A non-transitory computer readable medium having stored thereon instructions for generating a third-party lender overdraft line of credit comprising executable code which when executed by a processor, causes the processor to perform steps comprising accessing real-time bank account information. An insufficient fund amount is identified based on the real-time bank account information. An overdraft score is generated based on the insufficient fund amount, the real-time bank account information, and a third-party lender rule set established by a third-party lender and stored on the overdraft management computing device. An overdraft approval is provided when the overdraft score is above a threshold provided by the third-party lender and stored on the overdraft management computing device. The overdraft approval is provided without sending confidential user information to the third-party lender. An approval code is sent to the third-party lender. The approval code automatically generates the third-party lender overdraft line of credit for the user.

The present technology advantageously provides a solution rooted in computer technology to the computer network related problem of how to generate a third-party lender overdraft line of credit without comprising the user's bank account information. The present technology results in the following security improvements: (1) eliminating the possibility of a breach at the third-party lender's systems comprising the account holder's private transaction information or their Account Credentials as no confidential information is transmitted to the third-party lending bank; (2) eliminating the possibility of an interception of communications to or from the third-party lender that could lead to a security breach affecting the consumer in attempting to obtain an overdraft line of credit through a third-party lender; and (3) eliminating the need for faxed or e-mailed input by applicants for overdraft lines, thus improving data integrity for the third-party lender.

The present technology advantageously provides methods, devices, and computer readable non-transitory media that allow for complete underwriting of an overdraft line of credit from a third-party lender on the consumer device. The present technology improves the functionality of the consumer device by transferring the loan decision itself to the device of the consumer.

### BRIEF DESCRIPTION OF THE DRAWINGS

FIG. 1 is block diagram of an exemplary environment including an overdraft management computing device.

FIG. 2 is a block diagram of an example of an overdraft management computing device.

FIG. 3 is a flowchart of an exemplary method of generating a third-party lender overdraft line of credit of the present technology.

### DETAILED DESCRIPTION

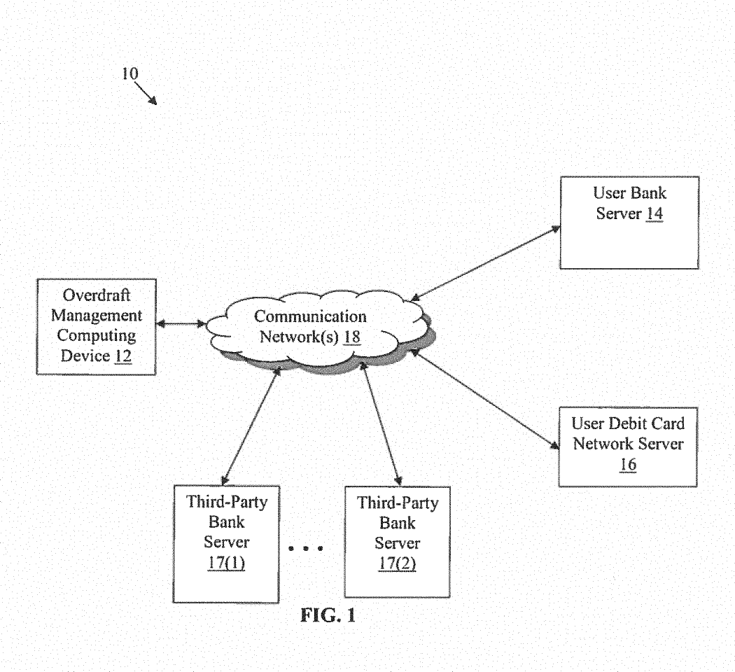

FIG. 1 illustrates an environment 10 with an overdraft management computing device 12 connected to a user bank server 14 associated with a bank account held by the user, a user debit card network server 16 associated with a debit card held by the user, and third-party bank servers 17(1)-17(n) connected via communication network(s) 18 to provide a secure and responsive environment for providing overdraft advances to non-account holders.

The environment 10 includes the overdraft management computing device 12 connected to the user bank server 14 via communication network(s) 18 through an internet banking portal. The overdraft management computing device 12 may access the user's bank account information in real-time from the user bank server 14. The overdraft management computing device 12 is further coupled to the users debit card network server 16 via communication network(s) 18. The overdraft management computing device 12 communicates with the user debit card network server 16, by way of example only, through an API such as MasterCard Send™. The user bank server 14 and the user debit card network server 16 are also connected via the communication network(s) 18 such that the user can access the user bank server 14 through the user debit card network server 16, by way of example. The overdraft management communicating device 12 is also connected to the third-party bank servers 17(1)-17(n) via the communication network(s) 18. The user debit card server 16 may also interact with the one or more of the third-party bank servers 17(1)-17(n). In one example, one of the third-party bank servers 17(1)-17(n) stores information related to a “due to account” related to the user debit card network server 16.

Although an exemplary environment 10 is described, the environment 10 can include any other number and types of systems, devices, components, and elements connected together in other configurations with other types and numbers of communications networks. This technology provides a number of advantages including real-time monitoring of account balances and ability to provide overdraft advances from third-party lenders, while restricting all confidential data to the overdraft management computing device 12 and limiting the confidential data to temporary use.

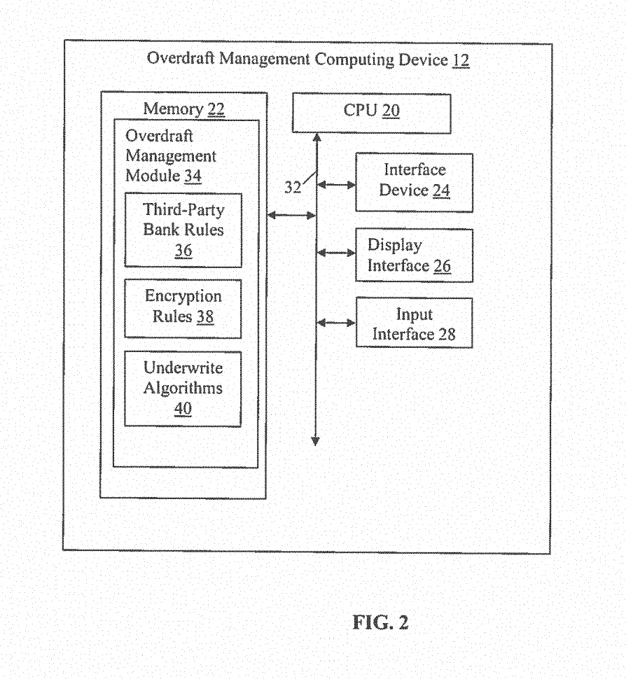

The overdraft management computing device 12 may be a mobile and/or smart phone, although the overdraft management device 12 can comprise other types and numbers of devices, such as a tablet computing device, PDA, minicomputer, and/or a laptop computing device by way of example. Referring more specifically to FIG. 2, the overdraft management computing device 12 includes a central processing unit (CPU) or processor 20, a memory 22, an interface device 24, a display interface 26, and an input interface 28 which may be separate or as a touchscreen on the display interface 26, all of which are coupled together by a bus 32 or other link, although the overdraft management computing device 12 may contain any other number and types of devices, components, and elements in other configurations.

The processor 20 in the overdraft management computing device 12 executes a program of stored instructions or derive the instructions through initial set of conditions and machine learning for one or more aspects of the present technology as described and illustrated by way of examples herein, although other types and numbers of processing devices and logic could be used and the processor 20 could execute other numbers and types of programmed or learned instructions.

The memory 22 in the overdraft management computing device 12 may store the programmed instructions for one or more aspects of the present technology as described and illustrated herein, although some or all of the programmed instructions could be stored and executed elsewhere. A variety of different types of memory storage devices, such as random access memory (RAM) or a read only memory (ROM) in the system or a hard disk, CD ROM, DVD ROM, or other computer readable medium which is read from and written to by a magnetic, optical, or other reading and writing system that is coupled to the processor 20, can be used for the memory 22. The memory 22 in the overdraft management computing device 12 may store programmed instructions for performing one or more aspects of the present technology described and illustrated in more detail below.

In one example, the memory 22 stores an overdraft management module 34 for performing one or more aspects of the present technology described and illustrated herein. Referring again to FIG. 1, the overdraft management module 34 includes at least one set of third-party bank rules 36 received from one or more of the third-party bank servers 17(1)-17(n). In one example, the overdraft management module 34 may include third-party bank rules from a number of the third-party bank servers 17(1)-17(n). The third-party bank rules 36 include, by way of example, the underwriting criteria, anti-fraud rules, know your client rules, and money laundering rules of at least one of the third-party banks associated with the third-party bank servers 17(1)-17(n). The overdraft management module 34 further includes encryption rules 38 for securely handling data.

The consumer can access the overdraft management module 34 only by fingerprint or facial recognition or similar authentication through a security input device configured to interact with the input interface 28 on the overdraft management computing device 12 as described below. While the consumers have access to transfer or enter data into the overdraft management module 34, they cannot override the decisions of the overdraft management module 34 as described in U.S. patent application Ser. No. 2010/0077230, the disclosure of which is hereby incorporated herein by reference in its entirety. The overdraft management module 34 further transmits the decision to lend or to decline with an approval code to the prospective third-party overdraft provider. Confidential information and Account Credentials are not permanently stored on, nor transmitted from the overdraft management computing device 12.

The third-party bank rules 36 are utilized to generate an underwriting framework summarized in underwrite algorithms 40 stored in the overdraft management module 34 of the overdraft management computing device 12. The underwrite algorithms 40 receive input data such as: (i) amount of time the account has been open; (ii) size and frequency of deposits; (iii) size, frequency, and duration of overdrafts; (iv) the frequency and amounts of NSF; (v) a predictive score resulting from machine learning and ongoing analysis of the user's bank transactions, by way of example only. The underwrite algorithms 40 utilize the inputs along with the third-party bank rules 36, which include a set of objective rules including underwriting criteria, fraud, and money-laundering prevention methods. The underwrite algorithms 40 and approval process are encrypted using the encryption rules 38 in the overdraft management module 34, such that the overdraft management module 34 serves as a “black box”, i.e., a non-transitory computer readable medium incorporating machine learning. The overdraft management module 34 is downloaded and stored in the memory 22 of the overdraft management computing device 12, and is protected against unauthorized use. The overdraft management module 34 uses the underwrite algorithms 40, based on the cash flow into the user bank accounts that the overdraft management module 34 monitors, to decide the size of future overdraft advances.

Referring again to FIG. 2, the interface device 24 in the overdraft management computing device 12 operatively couples and communicates between the overdraft management computing device 12 an at least the user bank server 14, the user debit card network server 16, and one or more of the third-party bank servers 17(1)-17(n), which are all coupled together by the communication network(s) 18, although other types and/or numbers of communication networks or systems with other types and/or numbers of connections and/or configurations to other devices and/or elements can also be used.

By way of example only, the communication network(s) 18 can include local area network(s) (LAN(s)) or wide area network(s) (WAN(s)), and can use TCP/IP over Ethernet and industry-standard protocols, although other types and/or numbers of protocols and/or communication networks can be used. The communication network(s) 18 in this example can employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The display interface 26 and the input interface 28 of the overdraft management computing device 12 enable a user, such as an user or an administrator, to interact with the overdraft management computing device 12, such as to input and/or view data and/or to configure, program and/or operate it by way of example only. Display devices configured to interact with the display interface 26 may include a computer monitor or touch screen device, while input devices configured to interact with the input interface 28 may include a keyboard, computer mouse, and/or touch screen, although other types and numbers of display and/or input interfaces could also be used in other examples. In one example, the input interface 28 is configured to interact with a finger print scanner or a built-in camera in the overdraft management computing device 12 for facial or iris recognition. The input interface 28 enables a user to securely access certain elements or functionalities of the overdraft management computing device 12, such as the overdraft management module 34.

The user bank server 14, user debit card network server 16, and the third-party bank servers 17(1)-17(n) may be hardware or software or may represent a system with multiple server computing devices in a server pool, which may include internal or external networks. The third-party bank servers 17(1)-17(n) are associated with third-party lending institutions that may utilize the technology to determine the user's need for overdraft funds as well as user's ability and willingness to repay. In this example the server devices may be any version of Microsoft® IIS servers or Apache® servers, although other types of server computing devices may be used. Further, additional server computing devices may be coupled to the communication network(s) 18 and many different types of applications may be available on each of the server computing devices.

Although an exemplary network environment 10 with the overdraft management computing device 12, user bank server 14, user debit card network server 16, and the third-party bank servers 17(1)-17(n), and communication network(s) 18 are described and illustrated herein, other types and numbers of systems, devices, components, and elements in other topologies can be used. It is to be understood that the systems of the examples described herein are for exemplary purposes, as many variations of the specific hardware and software used to implement the examples are possible, as will be appreciated by those skilled in the relevant art(s).

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and network traffic technologies.

The examples may also be embodied as a non-transitory computer readable medium having instructions stored thereon for one or more aspects of the present technology as described and illustrated by way of the examples herein, as described herein, which when executed by a processor, cause the processor to carry out the steps necessary to implement the methods of the examples, as described and illustrated herein.

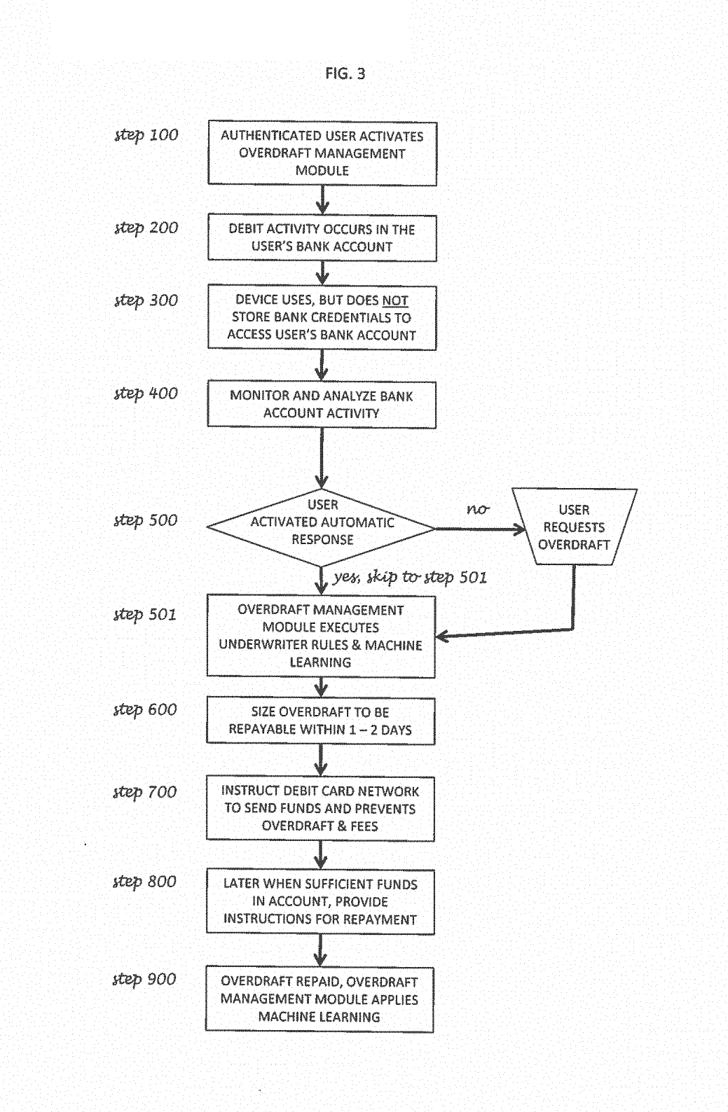

A method for providing overdraft lines to non-account holders will now be described with reference to FIGS. 1-3. While the technology is illustrated for overdraft lines, the improved security and elimination of the need for permanent storage of confidential data would apply to many types of loan products and receivable factoring, as well as financial products generally. Recent breaches of even the most secret national security databases may also lead to demand for enhanced privacy and security of data collection throughout commercial and government sectors. The current technology is equally applicable to financial as well as non-financial data and privacy protection.

At step 100, the user enters a password on an external keyboard or touch screen configured to interact with the input interface 28. In one example, the user is preapproved to utilize the overdraft management computing device 12 in accordance with know your client regulations. Additionally, the user provides a fingerprint or facial recognition authentication through a device configured to interact with the input interface 28 to unlock overdraft management computing device 12 and to activate the overdraft management module 34, although other security techniques may be utilized to initiate the methods of the present technology. After passing security checks, such as fingerprint recognition or inputting passwords or other unique identifiers (each a “user-recognition test”) through the input interface 28, the user can interact with the display interface 26 and the input interface 28 of the overdraft management computing device 12 to enable a user to interact with the overdraft management computing device 12. These interactions may include input and/or view data and/or to configure, program, and/or operate the overdraft management computing device 12. Encryption of certain parts of the program, as well as the user recognition test configured to interact with the input device 28 limit the interaction between user and overdraft management computing device 12 to authorized actions.

Next, at step 200, the user makes an online purchase using the overdraft management computing device 12 and debit card information stored in the memory 22, or makes a purchase at a physical store using the debit card, or uses the overdraft management computing device 12 to pay with charge card credentials stored in the memory 22 and accessed through interface 24, although the overdraft management computing device 12 may be used for other transactions. Other reasons for debit activity in the bank account include ATM withdrawals or presentation of physical or electronic checks (ACH).

At step 300, the user permits the overdraft management module 34 to access the user's bank account information stored at the user bank server 14 through an internet banking portal accessed on the overdraft management computing device 12 through account credentials stored in the memory 22 of the overdraft management computing device 12.

Virtually every checking account at a U.S. bank can be accessed through a debit card linked to the account, through the communication network(s) 18 connection the user bank server 14 and the user debit card network 16, by way of example. Debit cards are issued, among others, by Visa® and MasterCard®, collectively referred to as the operators of the debit card networks, such as a debit card network associated with the user debit card network server 16. Traditionally, debit cards were utilized to access funds in the account, for instance through purchases with the card or cash withdrawals at an ATM. More recently, the debit networks can be utilized to add funds instantaneously to a checking account, for instance using MasterCard Send™ or similar money transfer services. These options are in addition to more traditional bank transfers through ACH or instant-pay networks such as clearXchange or Zelle, which could be utilized as well.

Alternatively, the user may enter credentials to access the overdraft management module 34, for example by keying the credentials in on a keyboard or touch screen configured to interact with the input interface 28, by way of example, although other types and numbers of account information may be accessed. The user may alternatively opt for automatic monitoring by the overdraft management module 34 of potential account overdrafts based on data received from the user bank server 14. Most banks post the time at which they will determine the existence of an overdraft and impose fees. By way of example, at least one bank posts 11:00 pm EST for their determination time and the overdraft management module 34 may execute step 300 on a daily basis a brief moment before the determination time.

At step 400, the overdraft management module 34 receives real-time bank account information, by example, via communication network(s) 18 from the user bank server 14 through the account bank portal on the overdraft management computing device 12. The overdraft management module 34 processes the financial data based on underwrite algorithms 40 received from the third-party bank servers 17(1)-17(n) and stored in the memory 22 of the overdraft management computing device 12. The financial data is processed without sending any confidential information back to the prospective overdraft providers associated with third-party bank servers 17(1)-17(n).

Next, at step 500, if the overdraft management computing device 12 determines that insufficient funds are in the user's account based on the accessed real-time bank account information from the user bank server 14, by way of example, the overdraft management module 34 presents one or more options to the user. If the user has no overdraft line from the account bank associated with the user bank server 14, but does receive an offer from a third-party lender associated with one of the third-party bank servers 17(1)-17(n), the user can choose to accept or decline such offer. By way of example, the offer from the third-party lender is based on the analysis of the user's account information received from the user bank server 14 and the underwrite algorithms 40 stored in the overdraft management module 34, by way of example. If in step 500 the user declines the overdraft funds, the user requests and overdraft and there will be insufficient funds and returned-item fees, as well as potential reputational loss for the user and a credit score decline. In one example, the options are presented to the user on a device configured to interact with the display interface 26 of the overdraft management computing device 12 and the user may decline or accept the offer through a device, such as a keyboard or touchscreen configured to interact with the input interface 28. The user also has the option to choose an automatic setting for a default response to an offer for a overdraft credit line. By way of example, the user may set the overdraft computing device 12 to always accept the offers. The setting will remain the default until changed by the user.

If in step 500 the user accepts the offer for an overdraft line of credit from one of the financial institutions associated with the third-party bank servers 17(1)-17(n), then at step 501, the overdraft management computing device 12 receives the user's selection through the input interface 28 of the overdraft management computing device 12. By way example, the user at an ATM or POS may opt to complete purchase at this time, and thus to overdraft the user's account, by entering a decision by pressing a “Proceed” button on the overdraft management computing device 12 to provide instructions to proceed through the overdraft management module 34 which displays an interface on the a device, such as a screen, configured to interact with the display interface 26. As a result, the overdraft management module 34 will generate an overdraft score for the user's account based on underwrite algorithm 40 stored in the memory 22 of the overdraft computing device 12 and the information accessible through communication network(s) 18 from the user bank server 14, by way of example. The overdraft score is also generated using the third-party bank rules 36 received from one or more of the third-party bank servers 17(1)-17(n) and stored in the overdraft management module 34. In another example, the user may pre-select automatic execution at step 501 of a default response.

When the overdraft management computing device 12 detects an impending overdraft of the user's bank account it will generate a request for funds from a third-party lending institution associated with one of the third-party bank servers 17(1)-17(n), which is the new third-party overdraft provider. If the overdraft management computing device 12 calculates that the required funds are less than the maximum overdraft line approved for the user based on the third-party bank rules 36, the request is automatically executed. Using stored instructions and an API to communicate, the overdraft management computing device 12 sends a one-time token to the user debit network server 16 instructing to credit the user's bank account with the required funds. As further example, the user debit network server 16 may communicate with the third-party bank servers 17(1)-17(n), such as through a “Due to Account”. The relevant debit card issuer associated with the user debit card network server 16 will debit the account of the third-party lending bank associated with the third-party bank server 17(1)-17(n) by the same amount as advanced to the user bank account.

The third-party bank associated with the third-party bank server 17(1), by way of example, receives real-time updates on user's amount of line usage and repayments thereof from communication with the user debit card network server 16. Despite the autonomous, or self-drive, aspects of the technology, the third-party bank retains the ability to “slam on the brakes”, even in the absence of confidential user expenditure information. For instance, maximum line amounts that are derived by the underwrite algorithm 40 embedded on the overdraft management computing device 12, and maybe equal to a multiple of average daily deposits, can be overridden in instructions to the debit card company associated with the user debit card network 16 to be capped at a maximum fixed “starter” amount.

A significant improvement in security and privacy compared to previous art is that the data and account credentials from the user bank (accessed from the user bank server 14 through a portal on the overdraft management computing device 12) are not transmitted to the new overdraft-providing third-party bank associated with, by way of example, third-party bank server 17(1). Moreover, the data is neither stored by the third-party bank nor permanently stored on the overdraft management computing device 12. Rather the overdraft management computing device 12 applies the third-party bank rules 36 and underwrite algorithms 40 to evaluate the user's creditworthiness. Based on real-time account data obtained from the user bank server, required overdraft curing funds are provided. When the user's account has sufficient funds, the debit card is utilized to withdraw funds from the user's account and credited back with additional fees to an account associated with the third-party lending bank at the user debit card network server 16. This method of repayment of the advance is by way of illustration only, since other methods of repayment, such as ACH debits of the user bank account or any other payment form is feasible as well.

At step 600, the overdraft management module 34 sizes the overdraft such that user will be able to repay overdraft within a few days based on the pattern of previous deposits into the user's bank account as received from the user bank server 14.

The overdraft management module 34 does not store account credentials or confidential data, but applies underwrite algorithms 40 combined with sophisticated machine learning both stored on the memory 22 of the overdraft management computing device 12. In one example, the overdraft management module 34 renders the overdraft decision based on the computed overdraft score. The overdraft may be granted if the overdraft score is above a threshold, although other methods may be utilized to generate the overdraft decision.

Next, at step 700, the overdraft management module 34 provides the overdraft decision for display through the display interface 26 on by way of example a monitor or similar device for the user to see. Simultaneously, the overdraft management module 34 sends a message with an approval code to a third-party lending bank associated with one of the third-party bank servers 17(1)-17(n), or for example directly through the communication network(s) 18 to the user debit card network server 16 for immediate credit of the user's bank account, through this or similar system. In one example, the overdraft management module 34 sends a token back to the prospective lender, which responds with a deposit in the consumer's existing bank account. The lender needs no passwords or account credentials to make a deposit and can be repaid by ACH or MasterCard Send™, by way of example, neither of which requires the confidential account credentials. Thus, an overdraft line of credit is established through the third-party lender associated with one of the third-party bank servers 17(1)-17(n) without transmitting any confidential user information.

At step 800, the overdraft management module 34 monitors the bank account based on the accessed real-time bank account information, for instance through received from the user bank server 14 associated with the user's bank account, for deposits and sends instructions when sufficient funds are in the user's account to the third-party server 17(1)-17(n) associated with the third-party lending bank to use ACH system or the user debit card network server 16 to obtain re-payment of the overdraft line of credit and any associated fees.

At step 900, the overdraft management module 34 will reset for additional overdrafts based on observed activity in user bank account through information received from the user bank server 14. By way of example, the underwrite algorithm 40 stored on the overdraft management computing device 12 may be adjusted to take into account prior overdrafts in rendering the overdraft decision. By way of example, the underwrite algorithm 40 may consider the number of overdrafts, frequency of overdrafts, average amount of overdrafts, or other pertinent historical overdraft information in rendering subsequent overdraft decisions.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for generating a third-party lender line of credit, the method comprising:
accessing, by an overdraft management computing device, real-time bank account information of a user;
identifying, by the overdraft management computing device, an insufficient fund amount based on the real-time bank account information;
generating, by the overdraft management computing device, an overdraft score based on the insufficient fund amount, the real-time bank account information, and a third-party lender rule set established by a third-party lender and stored on the overdraft management computing device;
providing, by the overdraft management computing device, an overdraft approval when the overdraft score is above a threshold provided by the third-party lender and stored on the overdraft management computing device, wherein the overdraft approval is provided without sending user confidential information to the third-party lender; and
sending, by the overdraft management computing device, an approval code to the third-party lender, wherein the approval code automatically generates the third-party lender line of credit for the user.

2. The method of claim 1, further comprising:
displaying, by the overdraft management computing device, on a display interface of the customer computing device, an offer for the third-party lender line of credit for the user to select based on the real-time bank account information;
displaying, by the overdraft management computing device, on the display interface of the customer computing device, an identification of fees associated with the third-party lender line of credit; and
receiving, by the overdraft management computing device, a selection of whether to accept the offer for the third-party lender line of credit through a user input interface.

3. The method of claim 1, wherein the user does not hold an account with the third-party lender.

4. The method of claim 1 further comprising:
monitoring, by the overdraft management computing device, the real-time bank account information for a deposit of funds;
determining, by the overdraft management computing device, when sufficient funds are available for payment of the overdraft line of credit based on the deposit of funds; and
providing, by the overdraft management computing device, an instruction to a bank associated with the real-time bank account information to make repayment of the overdraft line of credit and fees associated with the overdraft line of credit.

5. The method of claim 1 further comprising:
displaying, by the overdraft management computing device, on a display interface of the customer computing device, one or more additional offers for third-party lender lines of credit.

6. The method of claim 1, wherein the generating the overdraft score is further based on historical overdraft data stored on the overdraft management computing device.

7. An overdraft management computing device, comprising a processor and a memory coupled to the processor which is configured to execute one or more programmed instructions comprising and stored in the memory to:
access real-time bank account information of a user;
identify an insufficient fund amount based on the real-time bank account information;
generate an overdraft score based on the insufficient fund amount, the real-time bank account information, and a third-party lender rule set established by a third-party lender and stored on the overdraft management computing device;
provide an overdraft approval when the overdraft score is above a threshold provided by the third-party lender and stored on the overdraft management computing device, wherein the overdraft approval is provided without sending user confidential information to the third-party lender; and
send an approval code to the third-party lender, wherein the approval code automatically generates the third-party lender line of credit for the user.

8. The device of claim 7, wherein the processor coupled to the memory is further configured to execute at least one additional programmed instruction comprising and stored in the memory to:
display on a display interface of the customer computing device, an offer for the third-party lender line of credit for the user to select based on the real-time bank account information;
display on the display interface of the customer computing device, an identification of fees associated with the third-party lender line of credit; and
receive a selection of whether to accept the offer for the third-party lender line of credit through a user input interface.

9. The device of claim 7, wherein the user does not hold an account with the third-party lender.

10. The device of claim 7, wherein the processor coupled to the memory is further configured to execute at least one additional programmed instruction comprising and stored in the memory to:
monitor the real-time bank account information for a deposit of funds;
determine when sufficient funds are available for payment of the overdraft line of credit based on the deposit of funds; and
provide an instruction to a bank associated with the real-time bank account information to make repayment of the overdraft line of credit and fees associated with the overdraft line of credit.

11. The device of claim 7, wherein the processor coupled to the memory is further configured to execute at least one additional programmed instruction comprising and stored in the memory to display on a display interface of the customer computing device, one or more additional offers for third-party lender lines of credit.

12. The device of claim 7, wherein the generating the overdraft score is further based on historical overdraft data stored on the overdraft management computing device.

13. A non-transitory computer readable medium having stored thereon instructions for generating a third-party lender overdraft line of credit comprising executable code which when executed by a processor, causes the processor to perform steps comprising:
accessing real-time bank account information of a user;
identifying an insufficient fund amount based on the real-time bank account information;
generating an overdraft score based on the insufficient fund amount, the real-time bank account information, and a third-party lender rule set established by a third-party lender and stored on the overdraft management computing device;
providing an overdraft approval when the overdraft score is above a threshold provided by the third-party lender and stored on the overdraft management computing device, wherein the overdraft approval is provided without sending user confidential information to the third-party lender; and
sending an approval code to the third-party lender, wherein the approval code automatically generates the third-party lender line of credit for the user.

14. The medium of claim 13 further having stored thereon at least one additional instruction that when executed by the processor causes the processor to perform at least one additional step comprising:
displaying on a display interface of the customer computing device, an offer for the third-party lender line of credit for the user to select based on the real-time bank account information;
displaying on the display interface of the customer computing device, an identification of fees associated with the third-party lender line of credit; and
receiving a selection of whether to accept the offer for the third-party lender line of credit through a user input interface.

15. The medium of claim 13, wherein the user does not hold an account with the third-party lender.

16. The medium of claim 13 further having stored thereon at least one additional instruction that when executed by the processor causes the processor to perform at least one additional step comprising:
monitoring the real-time bank account information for a deposit of funds;
determining when sufficient funds are available for payment of the overdraft line of credit based on the deposit of funds; and
providing an instruction to a bank associated with the real-time bank account information to make repayment of the overdraft line of credit and fees associated with the overdraft line of credit.

17. The medium of claim 13 further having stored thereon at least one additional instruction that when executed by the processor causes the processor to perform at least one additional step comprising displaying on a display interface of the customer computing device, one or more additional offers for third-party lender lines of credit.

18. The medium of claim 13, wherein the generating the overdraft score is further based on historical overdraft data stored on the overdraft management computing device.
